(19) United States
(12) Patent Application Publication
(10) Pub. No.: US 2026/0189261 A1
(43) Pub. Date: Jul. 2, 2026

(54) LOW SWING REPEATER CIRCUIT WITH TRANSITION CONTROL

(71) Applicant: Advanced Micro Devices, Inc., Santa Clara, CA (US)

(72) Inventors: Clinton Harold Parker, Fort Collins, CO (US); John Wuu, Fort Collins, CO (US)

(21) Appl. No.: 19/003,537

(22) Filed: Dec. 27, 2024

(51) Int. Cl. H04B 3/36

(52) U.S. Cl. CPC H04B 3/36

(57) ABSTRACT

In an implementation, a repeater circuit includes an input circuit configured to receive an input signal, a control circuit coupled to the input circuit, an output circuit coupled to the control circuit and configured to drive an output signal, and a feedback circuit coupled between the output circuit and the control circuit, wherein the control circuit is configured to operate the output circuit in a switching mode and operate the output circuit in a diode-connected mode to provide a reduced voltage swing responsive to the feedback circuit.

### BACKGROUND

Integrated circuits have become increasingly complex and power-hungry as they incorporate more functionality and higher performance capabilities. As chip sizes grow and clock speeds increase, routing signals on-chip has become a significant challenge. Power efficiency is a concern in modern integrated circuit design, particularly for high-performance processors, graphics chips, and other complex systems-on-chip.

### BRIEF DESCRIPTION OF THE DRAWINGS

For a more complete understanding of the present disclosure, and the advantages thereof, reference is now made to the following descriptions taken in conjunction with the accompanying drawings.

FIG. 1 illustrates a block diagram of a low swing repeater system, in accordance with some implementations.

FIG. 2 illustrates a detailed transistor-level schematic of a low swing repeater circuit, in accordance with some implementations.

FIG. 3 illustrates a waveform diagram depicting signal relationships in the low swing repeater circuit, in accordance with some implementations.

FIG. 4 illustrates a flowchart for operating a low swing repeater circuit, in accordance with some implementations.

FIG. 5 illustrates a flowchart for operating a low swing repeater circuit, in accordance with some implementations.

FIG. 6 illustrates a flowchart for operating a low swing repeater circuit, in accordance with some implementations.

Corresponding numerals and symbols in the different figures generally refer to corresponding parts unless otherwise indicated. The figures are drawn to clearly illustrate the relevant aspects of the implementations and are not necessarily drawn to scale. The edges of features drawn in the figures do not necessarily indicate the termination of the extent of the feature.

### DETAILED DESCRIPTION OF ILLUSTRATIVE IMPLEMENTATIONS

The making and using of various implementations are discussed in detail below. It should be appreciated, however, that the various implementations described herein are applicable in a wide variety of specific contexts. The specific implementations discussed are merely illustrative of specific ways to make and use various implementations, and should not be construed in a limited scope.

Reference to “an implementation,” “one implementation,” “an embodiment,” or “one embodiment” in the framework of the present description is intended to indicate that a particular configuration, structure, or characteristic described in relation to the implementation/embodiment is included in at least one implementation/embodiment. Hence, phrases such as “in one implementation” or “in one embodiment” that may be present in one or more points of the present description do not necessarily refer to one and the same implementation/embodiment. Moreover, particular conformations, structures, or characteristics may be combined in any adequate way in one or more implementations/embodiments. The references used herein are provided merely for convenience and hence do not define the extent of protection or the scope of the implementations/embodiments.

The present disclosure relates to power-efficient integrated circuit design, particularly addressing the challenge of long-distance signal routing in high-performance chips. As integrated circuits become increasingly complex and densely packed, efficiently transmitting signals across long on-chip distances has emerged as a need. Traditional approaches often rely on full-rail voltage swings, which can lead to substantial power consumption, especially when driving large capacitive loads or lengthy interconnect wires.

To address this issue, a low swing repeater circuit may be employed for power-efficient long-distance signal routing. This circuit may be designed to limit the output voltage swing when driving large capacitive loads, resulting in power savings. The low swing repeater circuit may incorporate an active inductive peaking mechanism, which may provide fast transitions followed by a relaxed drive strength. This approach allows for reduced power consumption while maintaining signal integrity and minimizing latency impacts.

The low swing repeater circuit comprised several components working together to achieve power savings. An input stage receives incoming signals, while a control stage generates the necessary control signals to manage the circuit's operation. The output stage is responsible for driving the reduced swing output signal, and a feedback mechanism helps coordinate the transition between different operating modes.

One of the features of this circuit is ability to operate in distinct phases. Initially, the circuit may function in a strong drive mode (which may also be referred to as a switching mode or saturated switching mode where transistors operate as switches) to ensure rapid signal transitions. Subsequently, based on feedback from the output, the circuit may transition to a reduced swing mode (which may also be referred to as a diode-connected mode where transistors operate as diode-connected devices). This dynamic operation allows for an optimal balance between speed and power efficiency.

In some implementations, the low swing repeater circuit may be designed to integrate seamlessly with existing integrated circuit designs. It can be compatible with standard cell area constraints and utilize standard power rails, allowing for straightforward incorporation into various chip designs without requiring significant modifications to existing architectures or power distribution networks.

By employing this low swing repeater circuit, integrated circuit designers may achieve substantial power savings in scenarios involving long-distance signal routing, such as in high-performance processors, graphics chips, and complex systems-on-chip. The power reduction may be particularly significant for large capacitive loads or long interconnect wires, contributing to overall improvements in chip efficiency and performance.

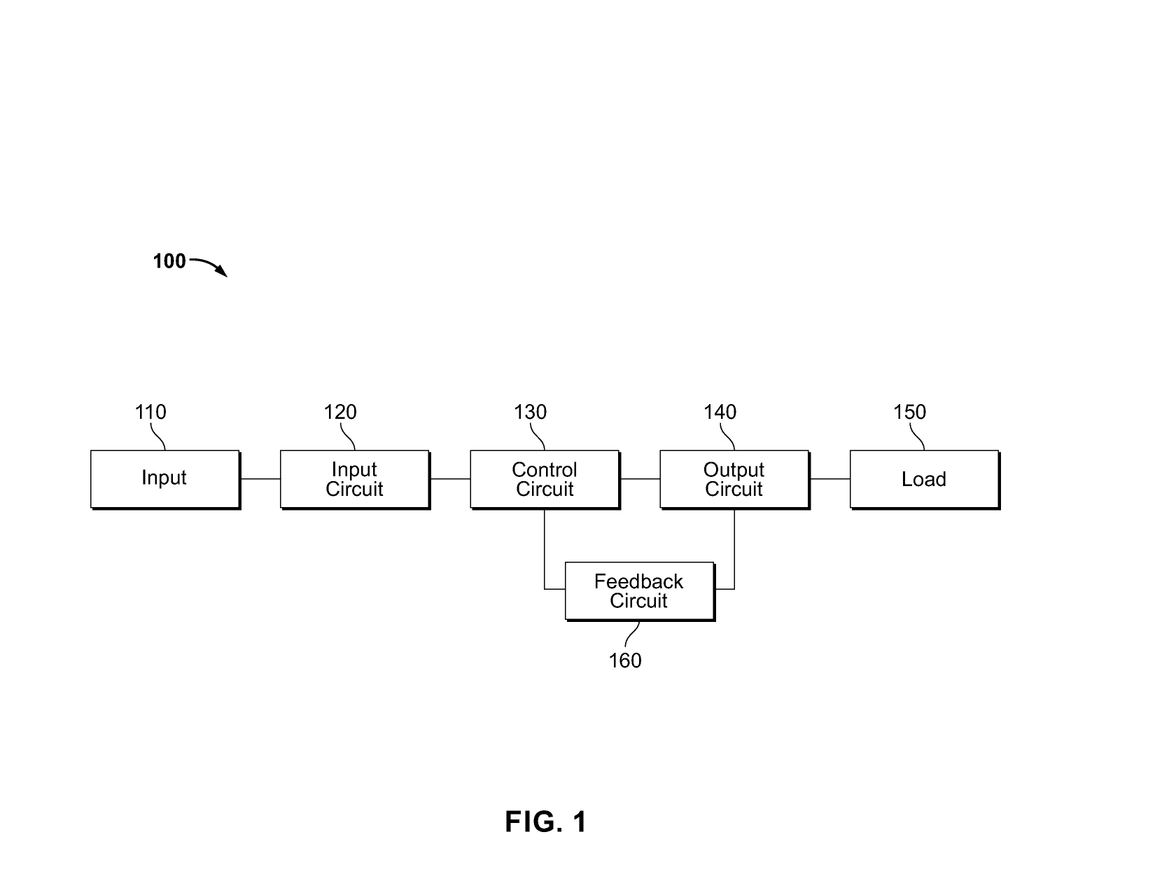

FIG. 1 illustrates a block diagram of a low swing repeater system according to various implementations. The low swing repeater system 100 comprises several components designed to efficiently transmit signals across long distances on an integrated circuit while minimizing power consumption. In some implementations, the repeater system 100 may include an input 110, an input circuit 120, a control circuit 130, an output circuit 140, a load 150, and a feedback circuit 160.

In some implementations, the input 110 is signals which may have reduced voltage swings from previous stages. These signals may be routed to the input circuit 120, which convert the incoming reduced-swing signals to full-rail internal signals. In some implementations, the input circuit 120 may comprise one or more inverters or buffer stages to restore signal integrity and prepare it for processing by subsequent stages.

The control circuit 130 is coupled to the input circuit 120 and is configured to generate control signals necessary for managing the operation of the low swing repeater system 100. In some implementations, the control circuit 130 may produce signals such as pdiode_gate and ndiode_gate, which may be used for controlling the output circuit 140. These control signals may determine the operating mode of the output transistors, allowing for dynamic switching between strong drive and reduced swing modes.

The output circuit 140, coupled to the control circuit 130, is configured to drive the output signal with a reduced voltage swing. In some implementations, the output circuit 140 may comprise an output p-channel field effect transistor (PFET) and an output n-channel field effect transistor (NFET), which work in tandem to produce the desired output characteristics.

The output circuit 140 is designed to drive the load 150, which in some implementations, is a large capacitive load or a long wire segment. These types of loads and wire segments may be found in integrated circuits.

A feedback circuit 160 is coupled between the output circuit 140 and the control circuit 130. This feedback mechanism monitors the output voltage level and provides information to the control circuit 130, allowing for precise timing control of mode transitions. In some implementations, the feedback circuit 160 generates a Zinv signal based on the output signal, which is used by the control circuit 130 to control the timing of transitions between strong drive and reduced swing modes.

The low swing repeater system 100 operates between power supply rails VDD and VSS. However, the output swing is intentionally limited to reduce power consumption when driving large capacitive loads. This reduced swing operation is particularly beneficial in scenarios involving long-distance signal routing, such as in high-performance processors, graphics chips, and complex systems-on-chip.

In some implementations, an integrated circuit comprises a plurality of low swing repeater systems 100, strategically placed to drive signals across long wire segments. This arrangement allows for efficient signal propagation across the chip while minimizing overall power consumption. The use of multiple low swing repeater systems 100 enables designers to optimize power efficiency in large-scale integrated circuits without compromising signal integrity or timing requirements.

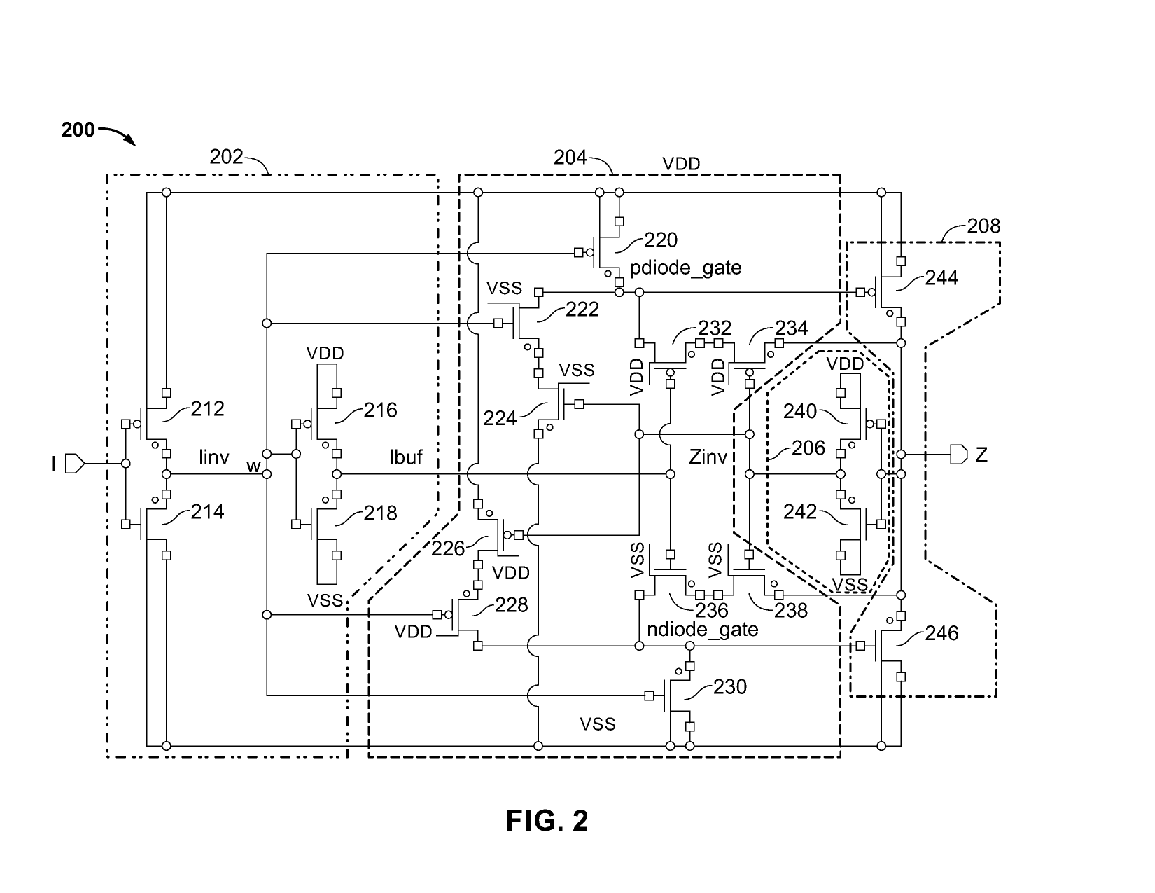

FIG. 2 illustrates a detailed transistor-level schematic of a low swing repeater circuit according to various implementations. The low swing repeater circuit 200 includes an input circuit 202, a control circuit 204, an output circuit 208, and a feedback circuit 206.

The input circuit 202 comprises a first inverter formed by a first inverter PFET 212 and a first inverter NFET 214, followed by a second inverter formed by a second inverter PFET 216 and a second inverter NFET 218. This dual inverter arrangement provides signal conditioning and level restoration for the input signals.

The control circuit 204 includes an upper control path and a lower control path. The upper control path comprises an upper control PFET 220 and second upper control NFET 222 configured as an inverting stage with gates connected to Iinv. The upper path also includes first feedback-controlled PFET 232 with gate controlled by Ibuf and second feedback-controlled PFET 234 with gate controlled by Zinv, providing dual-controlled access between pdiode_gate and the output Z.

The lower control path comprises a lower control NFET 224 with gate connected to Ibuf, an upper control PFET 226 with gate connected to Zinv, and first and second lower control NFETs 228 and 230 with gates connected to Iinv. The lower path additionally includes first feedback-controlled NFET 236 with gate controlled by Ibuf and second feedback-controlled NFET 238 with gate controlled by Zinv, providing similar dual-controlled access between ndiode_gate and output Z.

These control paths work together to produce pdiode_gate and ndiode_gate signals through their respective transistor configurations. Each control path includes specific transistor configurations designed to manage the mode transitions and achieve the desired voltage swing characteristics.

The output circuit 208 comprises an output PFET 244 and output NFET 246. These transistors are specifically sized and configured to provide both strong drive capability when operating as switches and controlled voltage limiting when operating as diode-connected devices.

The feedback circuit 206 comprises a feedback inverter PFET 240 and feedback inverter NFET 242 configured to generate the Zinv signal. The feedback inverter's switching threshold is designed to trigger at specific output voltage levels, ensuring proper timing of the mode transitions.

The transistors in the circuit are arranged to implement two distinct operating modes while maintaining compatibility with standard cell design rules and power rail requirements. The specific transistor sizes and threshold voltages are selected to achieve the target performance characteristics across process variations and operating conditions.

The control circuit 204's upper path employs transistors 220 and 222 as an inverting stage driven by Iinv, followed by the dual-controlled transistor pair 232 and 234. When Iinv transitions low, PFET 220 begins charging pdiode_gate, while a high Iinv enables NFET 222 to discharge pdiode_gate. The connection between pdiode_gate and output Z is controlled by both Ibuf through PFET 232 and the feedback signal Zinv through PFET 234, allowing for precise timing of the diode-connection phase.

The lower control path operates through a network of transistors 224, 226, 228, and 230, with 236 and 238 providing controlled connection to the output. NFET 224 responds to Ibuf, while PFET 226 is controlled by the feedback signal Zinv. NFETs 228 and 230, controlled by Iinv, provide additional control over ndiode_gate generation. The connection between ndiode_gate and output Z is controlled by both Ibuf through NFET 236 and Zinv through NFET 238.

The control circuit 204 thus helps to manage the operation of the output circuit 208 through its upper and lower control paths. These paths generate specific control signals that are for achieving the desired reduced voltage swing and active inductive peaking behavior.

The upper control path is responsible for generating the pdiode_gate signal, which controls the output PFET 244. The pdiode_gate signal controls the transition of the output PFET 244 between two distinct operating modes. This signal generation begins with transistors 220 and 222, which form an inverting stage responding to Iinv transitions. When Iinv is low, PFET 220 charges pdiode_gate high, while when Iinv is high, NFET 222 pulls pdiode_gate low. During a rising output transition, the pdiode_gate signal is driven to a low voltage level. This low voltage causes the output PFET 244 to operate as a switch, providing a strong drive that contributes to the fast edge rates observed in the output signal. This strong drive helps to maintain signal integrity and minimize propagation delays.

Following this phase, the pdiode_gate signal is connected to the output Z through transistors 232 and 234. PFET 232, controlled by lbuf, and PFET 234, controlled by the feedback signal Zinv, work together to establish the connection between pdiode_gate and output Z. This dual-control mechanism, using both the buffered input signal and feedback state, provides precise timing control over when the diode-connection is established.. This connection causes the output PFET 244 to transition from switch operation to functioning as a diode-connected device as the gate and drain of the PFET 244 are connected together. This transition achieves the reduced voltage swing, as the diode-connected configuration limits or sets the upper voltage of the output signal to approximately VDD minus the threshold voltage of the PFET.

The lower control path operates in a complementary manner, generating the ndiode_gate signal for controlling the output NFET 246. This path employs transistors 224, 226, 228, and 230 to generate ndiode_gate. NFET 224 responds to Ibuf, while PFET 226 is controlled by the feedback signal Zinv. NFETs 228 and 230 provide additional control based on Iinv. During a falling output transition, the ndiode_gate signal is driven to a high voltage level. This high voltage causes the output NFET 246 to operate as a switch, providing strong pull-down capability. This strong drive ensures rapid signal transitions during the falling edge.

Subsequently, similar to the PFET control, the ndiode_gate signal is connected to the output Z through the transistors 236 and 238 after the drive phase. NFET 236, controlled by lbuf, and NFET 238, controlled by Zinv, work together to manage the connection between ndiode_gate and output Z. This arrangement provides coordinated control using both the buffered input signal and feedback state. This connection causes the output NFET 246 to operate as a diode-connected device as the gate and drain of the NFET 246 are connected together, limiting or setting the lower voltage of the output signal to approximately VSS plus the threshold voltage of the NFET.

The coordinated operation of the control paths, through transistors 220-222 and 224-230, along with the dual-controlled transistor pairs 232-234 and 236-238, where one transistor responds to the buffered input (Ibuf) and the other to feedback (Zinv), allows the circuit to achieve both fast edge rates and reduced voltage swing. This dynamic control allows the circuit to provide the strong drive necessary for rapid signal transitions, followed by a controlled limitation of the voltage swing to reduce power consumption, particularly when driving large capacitive loads or long interconnect wires.

The feedback circuit 206 comprises a feedback inverter formed by PFET 240 and NFET 242 configured to generate a Zinv signal based on the output signal. In some implementations, the Zinv signal controls the timing of transitions between the strong drive mode and the reduced swing mode. The Zinv signal connects to PFET 234 and NFET 238 in the control paths, as well as to PFET 226, enabling coordination between the feedback state and the control path operations. This interconnection allows the feedback signal to influence both the timing of diode-connection and the generation of control signals. This feedback mechanism allows for precise control over the circuit's operation, ensuring optimal balance between speed and power efficiency. The feedback circuit monitors the output voltage level and provides the Zinv signal to the control circuit 130, which can be used to time the mode transitions. In some implementations, this feedback-based control approach may enhance the circuit's ability to adapt to varying load conditions or supply voltage fluctuations, improving overall performance and reliability across different operating scenarios.

In some implementations, the output PFET 244 and the output NFET 246 are low threshold voltage devices. This characteristic allows for adjustable output voltage swing limits, providing flexibility in tailoring the circuit's performance to specific application requirements. The use of low threshold voltage devices contributes to the circuit's ability to achieve reduced voltage swings while maintaining adequate signal integrity.

Driving the output signal comprises operating the output PFET 244 and the output NFET 246 in a coordinated manner. In some implementations, these transistors operate as switches during the strong drive mode, providing fast signal transitions. Subsequently, they transition to operate as diode-connected devices during the reduced swing mode, limiting the output voltage swing and contributing to power savings.

The output swing range of the circuit is directly related to the threshold voltages of the output transistors. In some implementations, using low threshold voltage (low-Vt) transistors with typical threshold voltages between 200-300mV results in output swings ranging from approximately 200mV to VDD-200mV. Using standard threshold voltage devices (standard-Vt) with typical threshold voltages between 400-500mV further reduces the swing range to approximately 400mV to VDD-400mV, providing additional power savings at the cost of noise margin. In some implementations, high threshold voltage devices (high-Vt) with threshold voltages between 600-700mV can be used for maximum power savings in applications where larger noise margins are not required.

The selection of threshold voltage for the output transistors allows designers to optimize the trade-off between power savings and noise margin based on specific application requirements. In some implementations, the output swing can be characterized by the equation Vswing = VDD - 2*Vt for symmetrical PFET and NFET threshold voltages, where Vt represents the threshold voltage of the output transistors.

The interaction between the control circuit 204, feedback circuit 206, and output circuit 208 enables the low swing repeater circuit 200 to achieve its dual objectives of fast signal propagation and reduced power consumption. The dynamic transition between operating modes, facilitated by the control and feedback mechanisms, allows the circuit to adapt its behavior based on the current state of the output signal, optimizing performance across various operating conditions.

The operation of the low swing repeater circuit 200 implements a coordinated sequence of events to achieve optimal performance. When a transition begins, the control circuit 204 configures the output transistors as switches by manipulating the control signals.

For a rising output transition, the control circuit 204 drives pdiode_gate to a low voltage level, enabling the output PFET 244 to provide maximum pull-up strength. For a falling transition, ndiode_gate is driven high to enable strong pull-down through the output NFET 246. This initial strong drive phase provides the fast edge rates needed for rapid signal propagation.

The feedback circuit 206 monitors the output voltage through the Zinv signal. When the output crosses the feedback inverter threshold (typically near VDD/2), it triggers the transition from strong drive to reduced swing mode. This threshold crossing indicates that sufficient charge has been transferred to ensure proper signal propagation.

Upon the threshold crossing, the pdiode_gate and ndiode_gate signals are connected to the output Z. This causes the output transistors to self-bias into diode-connected configurations. In this state, the PFET limits the upper voltage to approximately VDD minus its threshold voltage, while the NFET limits the lower voltage to approximately VSS plus its threshold voltage.

The timing of this mode transition needs to be precise - too early and the signal may not propagate properly, too late and power is wasted. The feedback mechanism automatically adjusts this timing based on actual circuit conditions including load capacitance, process variations, and supply voltage.

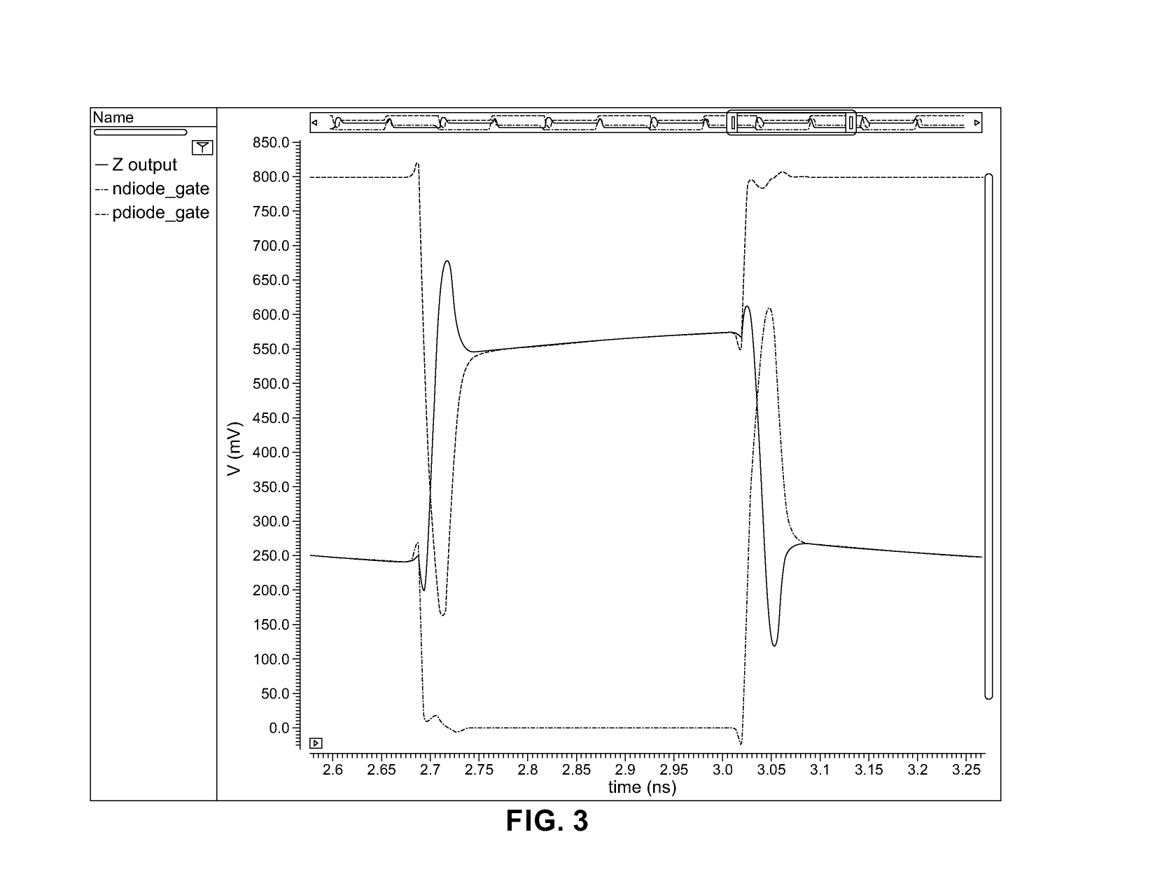

FIG. 3 illustrates a waveform diagram depicting signal relationships in the low swing repeater circuit according to various implementations. The diagram shows the temporal relationships between the input signal (I), control signals (pdiode_gate and ndiode_gate), and output signal (Z).

The input signal exhibits full rail-to-rail transitions between VSS and VDD, triggering the circuit's dynamic behavior. The signal relationships visible in the waveform diagram demonstrate several operating characteristics:

First, the active inductive peaking effect is evident in the output waveform. This appears as controlled overshoot and undershoot of the output signal Z before it settles to its final voltage levels. During a rising transition, Z temporarily exceeds its steady-state high level due to the strong initial drive phase. Similarly, during falling transitions, Z drops below its steady-state low level. This overshoot/undershoot behavior is intentionally designed to achieve faster overall transition times.

Second, the diagram shows precise timing relationships between control signals. The pdiode_gate signal drives low at the start of rising transitions while ndiode_gate remains high, creating an initial strong pull-up path. Conversely, during falling transitions, ndiode_gate drives high while pdiode_gate stays low, enabling strong pull-down. The duration of these strong drive phases is controlled by the feedback mechanism.

Third, the Zinv signal transitions demonstrate the feedback control timing. When Z crosses the feedback threshold (VDD/2), Zinv switches, and the pdiode_gate and ndiode_gate signals then are connected to the output Z and that bias the output transistors into diode-connected configuration.

Fourth, the output signal Z exhibits reduced voltage swing during steady-state, never reaching the full power supply rails. The upper voltage limit stays below VDD by approximately one threshold voltage, while the lower limit remains above VSS by the same amount. This reduced swing directly enables power savings.

The waveforms also demonstrate the circuit's ability to maintain fast edge rates despite the reduced voltage swing. The initial strong drive phase provides the rapid transitions needed for good signal integrity, while the diode-connected phase maintains the power-efficient reduced swing. This combination of features enables the circuit to achieve both high performance and improved power efficiency.

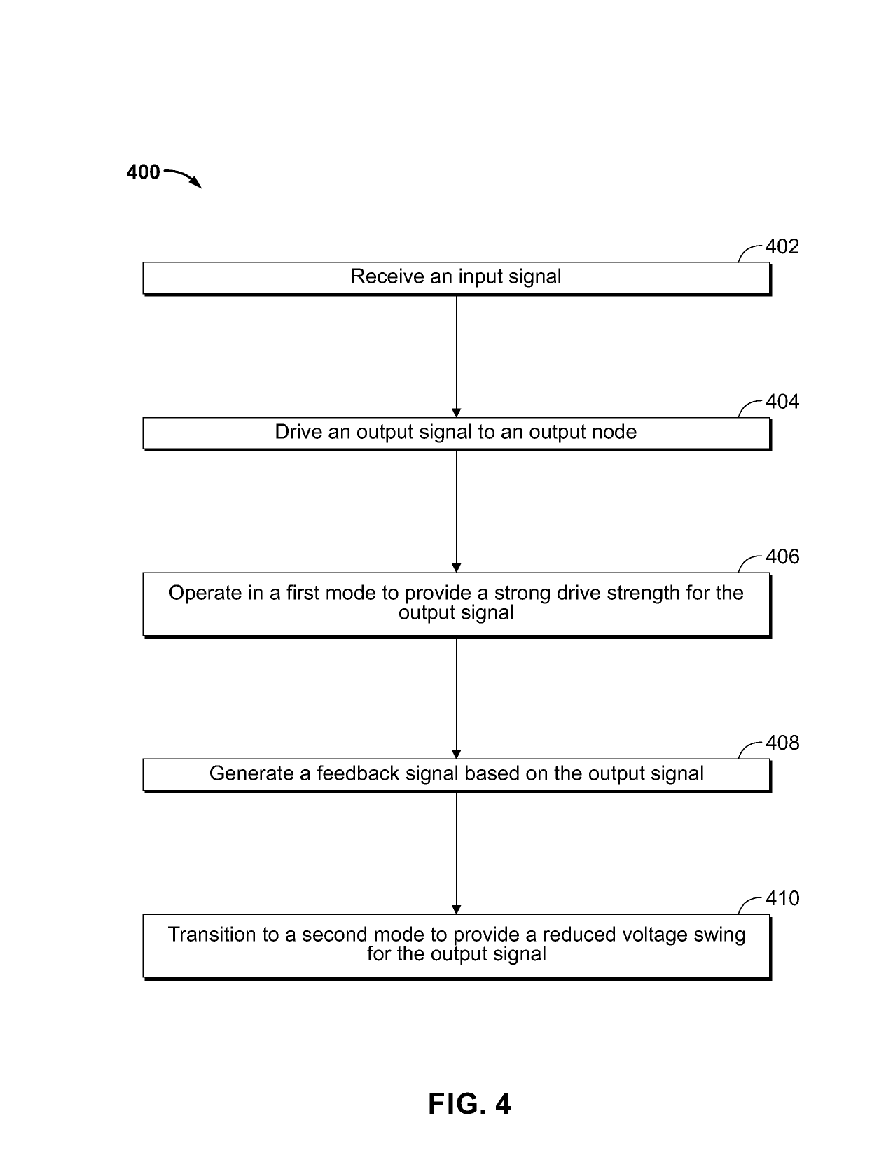

FIG. 4 illustrates a flowchart for a method 400 of operating a low swing repeater circuit according to various implementations. The method 400 begins with step 402 of receiving an input signal. In some implementations, this input signal is received by an input circuit, such as the input circuit 202 described in relation to FIG. 2. The input signal may have a full rail-to-rail swing or may be a reduced swing signal from a previous stage.

Following the reception of the input signal, the method 400 proceeds to step 404 of driving an output signal to an output node. In some implementations, this step is performed by an output circuit, such as the output circuit 208 described earlier. The output signal may be driven with a reduced voltage swing compared to traditional full-swing circuits, resulting in power savings when driving large capacitive loads or long interconnect wires.

The next step 406 in the method 400 involves operating in a first mode to provide a strong drive strength for the output signal. In some implementations, this mode involves operating the main output PFET and main output NFET as switches, providing strong pull-up and pull-down capabilities respectively. This initial strong drive may allow for rapid signal transitions at the output, contributing to fast edge rates in the output signal.

The method then proceeds to step 408 of generating a feedback signal based on the output signal. In some implementations, this step is performed by a feedback circuit, such as the feedback circuit 206 described earlier. The feedback circuit generates a Zinv signal based on the output signal, which is used to control the timing of the transition between the strong drive mode and the reduced swing mode.

Finally, step 410 of the method 400 involves transitioning to a second mode to provide a reduced voltage swing for the output signal in response to the feedback signal. In some implementations, this transition involves operating the main output PFET and main output NFET as diode-connected devices. This configuration limits the output voltage swing, resulting in power savings when driving large capacitive loads or long interconnect wires. The transition between modes may be precisely timed to achieve a balance between fast edge rates and reduced voltage swing operation.

The method 400 illustrated in FIG. 4 may allow the low swing repeater circuit to dynamically adapt its operation based on the current state of the output signal. By initially providing strong drive capability and then transitioning to a power-saving mode, the circuit optimizes its performance across various operating conditions and load characteristics. This approach results in improved power efficiency compared to traditional full-swing repeaters, particularly when driving large capacitive loads or long interconnect wires in complex integrated circuits.

The method 400 illustrated in FIG. 4 is an example implementation, and the disclosure contemplates various other implementations with different arrangements of steps. In some aspects, the steps may be performed in a different order than shown in FIG. 4. For instance, the driving of the output signal and the operation in the first mode may occur simultaneously in some implementations. Additionally, some steps may be performed in parallel rather than sequentially. For example, the generation of the feedback signal and the transition to the second mode may overlap in time. Furthermore, additional steps may be included, or some steps may be omitted or combined, depending on the specific requirements of the implementation. The flexibility in the arrangement and execution of these steps may allow the low swing repeater circuit to be adapted for various applications and operating conditions.

In some implementations, the method 400 may be performed by a repeater circuit comprising an input circuit, a control circuit, an output circuit, and a feedback circuit. The input circuit may receive the input signal. The control circuit may be coupled to the input circuit and may generate control signals for managing the operation of the repeater circuit. The output circuit may be coupled to the control circuit and may drive the output signal. The feedback circuit may be coupled between the output circuit and the control circuit and may generate the feedback signal based on the output signal. This arrangement may allow for efficient implementation of the method 400 in integrated circuit designs.

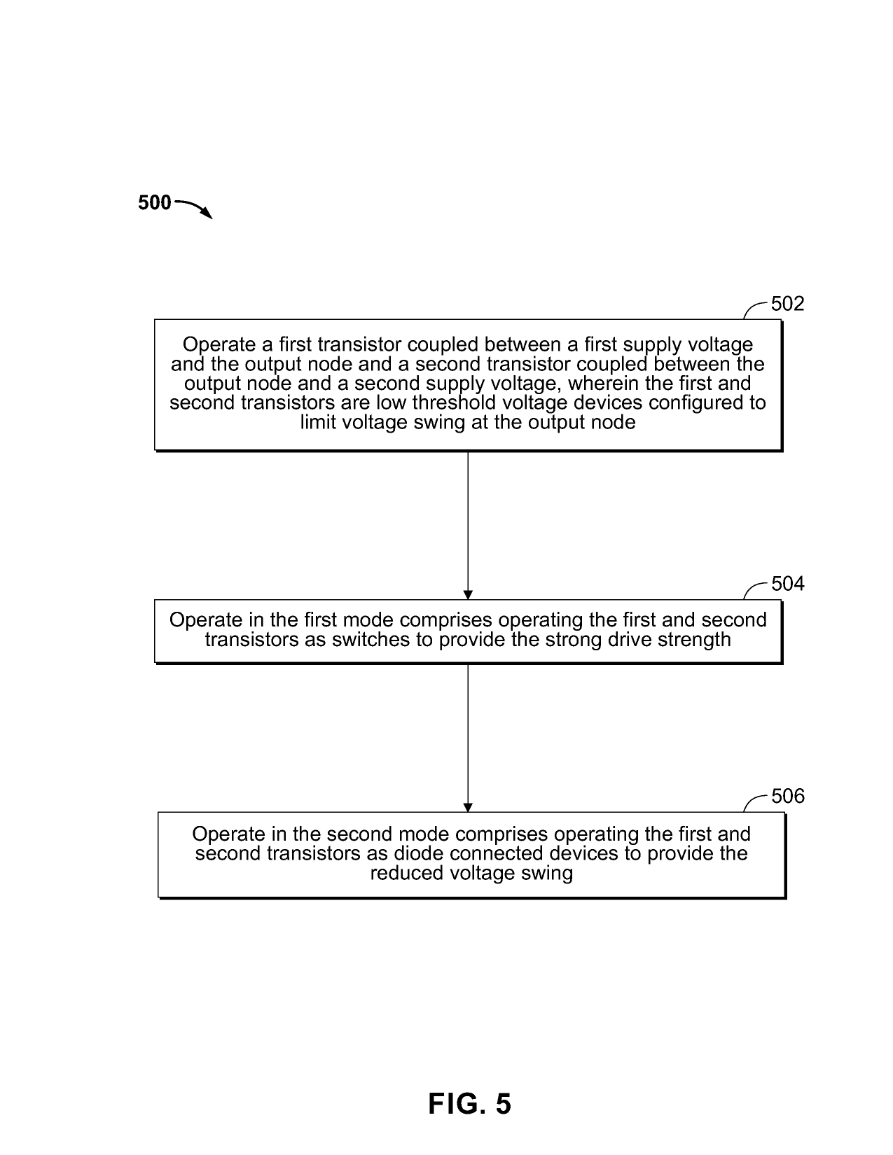

FIG. 5 illustrates a flowchart of a method 500 for operating a repeater circuit with reduced voltage swing. The method 500 comprises steps that describe the operation of driving the output signal to the output node.

The method 500 begins with step 502, which involves operating a first transistor coupled between a first supply voltage and the output node and a second transistor coupled between the output node and a second supply voltage. The first and second transistors are specified as low threshold voltage devices configured to limit voltage swing at the output node.

Following step 502, the method 500 proceeds to step 504. This step describes operating in a first mode, which comprises operating the first and second transistors as switches to provide strong drive strength. This operation allows for fast initial transitions of the output signal.

The final step in the method 500 is step 506. This step involves operating in a second mode, which comprises operating the first and second transistors as diode-connected devices to provide the reduced voltage swing. This operation allows for power-efficient steady-state operation.

The flowchart illustrates the sequential nature of the method 500, with each step leading directly to the next. The method 500 demonstrates the dual-mode operation of the repeater circuit, transitioning from a high-drive strength mode to a power-saving reduced swing mode. This approach combines fast signal propagation with energy efficiency in driving large capacitive loads or long interconnects.

The method 500 illustrated in FIG. 5 is an example implementation, and the disclosure contemplates various other implementations with different arrangements of steps. In some aspects, the steps may be performed in a different order than shown in FIG. 5. For instance, the operation of the first and second transistors may occur simultaneously with the operation in the first mode in some implementations. Additionally, some steps may be performed in parallel rather than sequentially. For example, the transition to the second mode may begin before the first mode operation is fully complete. Furthermore, additional steps may be included, or some steps may be omitted or combined, depending on the specific requirements of the implementation. The flexibility in the arrangement and execution of these steps may allow the low swing repeater circuit to be adapted for various applications and operating conditions.

In some implementations, the method 500 may be performed by a repeater circuit comprising an input circuit, a control circuit, an output circuit, and a feedback circuit. The input circuit may receive the input signal. The control circuit may be coupled to the input circuit and may generate control signals for managing the operation of the repeater circuit. The output circuit may include the first and second transistors and may drive the output signal. The feedback circuit may be coupled between the output circuit and the control circuit and may facilitate the transition between the first and second modes of operation. This arrangement may allow for efficient implementation of the method 500 in integrated circuit designs.

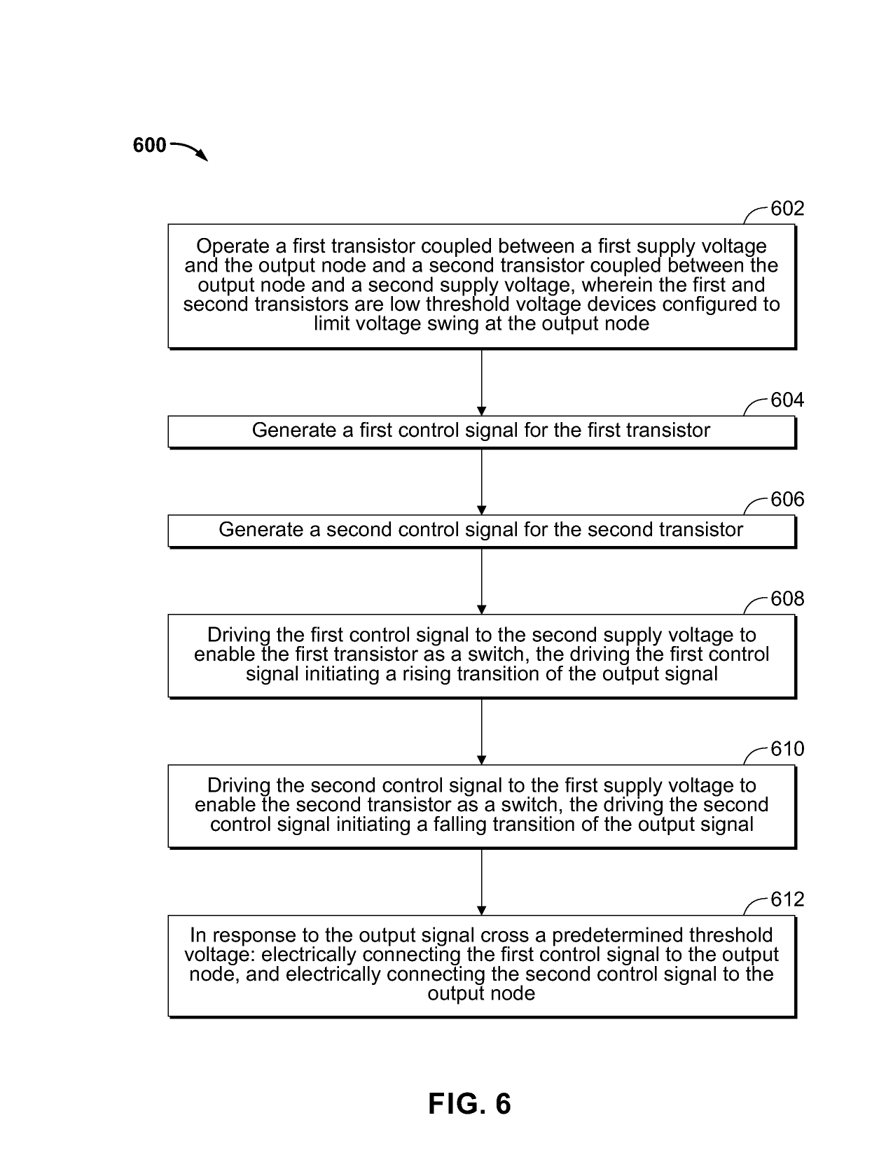

FIG. 6 illustrates a flowchart of a method 600 for operating a repeater circuit with reduced voltage swing. The method 600 comprises steps that describe the operation of driving the output signal to the output node.

The method 600 begins with step 602, which involves operating a first transistor coupled between a first supply voltage and the output node, and a second transistor coupled between the output node and a second supply voltage. These transistors are low threshold voltage devices configured to limit voltage swing at the output node.

The method 600 then proceeds to step 604, where a first control signal is generated for the first transistor. This is followed by step 606, which involves generating a second control signal for the second transistor.

In step 608, the method 600 drives the first control signal to the second supply voltage to enable the first transistor as a switch, the driving the first control signal initiating a rising transition of the output signal. In step 610 the second control signal is driven to the first supply voltage to enable the second transistor as a switch, , the driving the second control signal initiating a falling transition of the output signal.

In step 612 of the method 600 occurs in response to the output signal crossing a predetermined threshold voltage. At this point, the method 600 electrically connects the first control signal to the output node, and electrically connects the second control signal to the output node.

The flowchart demonstrates the sequence of operations in the repeater circuit, highlighting the transition between strong drive mode (where transistors act as switches) and reduced swing mode (where transistors are diode-connected). This method 600 allows for initial fast transitions followed by power-saving reduced voltage swing operation.

The method 600 illustrated in FIG. 6 is an example implementation, and the disclosure contemplates various other implementations with different arrangements of steps. In some aspects, the steps may be performed in a different order than shown in FIG. 6. For instance, the generation of the first and second control signals may occur simultaneously in some implementations. Additionally, some steps may be performed in parallel rather than sequentially. For example, the driving of the control signals and the monitoring of the output signal crossing the threshold may occur concurrently. Furthermore, additional steps may be included, or some steps may be omitted or combined, depending on the specific requirements of the implementation. The flexibility in the arrangement and execution of these steps may allow the low swing repeater circuit to be adapted for various applications and operating conditions.

In some implementations, the method 600 may be performed by a repeater circuit comprising an input circuit, a control circuit, an output circuit, and a feedback circuit. The input circuit may receive the input signal. The control circuit may be coupled to the input circuit and may generate the first and second control signals for managing the operation of the repeater circuit. The output circuit may include the first and second transistors and may drive the output signal. The feedback circuit may be coupled between the output circuit and the control circuit and may detect when the output signal crosses the predetermined threshold voltage. This arrangement may allow for efficient implementation of the method 600 in integrated circuit designs.

The low swing repeater circuit disclosed herein (see, e.g., low swing repeater circuit 200) is designed to efficiently drive a range of capacitive loads, particularly those associated with long interconnect wires in complex integrated circuits. In some implementations, the circuit 200 is optimized for driving loads in the range of 25-150 microns. This range corresponds to typical wire lengths encountered in high-performance processors, graphics chips, and other complex systems-on-chip where long-distance signal routing is required.

For target applications within this load range, the low swing repeater circuit 200 achieves power savings of approximately 15-20% compared to traditional full-swing repeaters. These power savings are due to the reduced voltage swing operation of the circuit, which results in lower dynamic power consumption when driving large capacitive loads. In some implementations, the power savings are even greater for larger loads, such as those encountered in global clock distribution networks.

The implementation of the low swing repeater circuit 200 requires additional transistors compared to standard repeater designs. In some implementations, the circuit 200 is approximately double the size of a standard inverter and 50% larger than a standard buffer. This increased size is due to the additional control and feedback circuitry to implement the dynamic transition between strong drive and reduced swing modes. Despite the larger size, the power savings achieved by the circuit outweigh the area overhead in applications where power efficiency is a primary concern. Moreover, the circuit 200 fits within a standard cell and uses the standard power rails, allowing for straightforward integration into existing chip designs.

One of the advantageous features of the low swing repeater circuit 200 is its ability to adjust the output swing range. In some implementations, this adjustment is achieved by changing the threshold voltage (Vt) type of the output transistors. For instance, using low threshold voltage devices for the output PFET 244 and output NFET 246 results in a larger output swing, while using high threshold voltage devices further reduces the swing and increases power savings. This flexibility allows designers to fine-tune the circuit's performance for specific application requirements.

In some implementations, the low swing repeater circuit 200 is made programmable to adjust the output swing range dynamically. This programmability is achieved by incorporating additional control circuitry that allows for switching between different threshold voltage devices or adjusting the bias conditions of the output transistors. A programmable design provides even greater flexibility, allowing the circuit to adapt to varying load conditions or power requirements in different operating modes of the integrated circuit.

The ability to customize the output swing and make it programmable offers advantages in complex system-on-chip designs. For example, in some implementations, the low swing repeater circuit 200 is configured to provide maximum power savings during low-power operating modes, while still maintaining the capability to switch to higher performance modes when required. This adaptability contributes to overall system efficiency and is particularly beneficial in applications with varying performance and power requirements.

In an implementation, a repeater circuit includes an input circuit configured to receive an input signal, a control circuit coupled to the input circuit, an output circuit coupled to the control circuit and configured to drive an output signal, and a feedback circuit coupled between the output circuit and the control circuit, wherein the control circuit is configured to operate the output circuit in a switching mode and operate the output circuit in a diode-connected mode to provide a reduced voltage swing responsive to the feedback circuit.

The described implementations may also include one or more of the following features. The output circuit includes a first transistor coupled between a first supply voltage and an output node and a second transistor coupled between the output node and a second supply voltage. In the switching mode, the first and second transistors are configured to operate as switches and in the diode-connected mode, the first and second transistors are configured to operate as diode-connected devices. The control circuit includes a first control path configured to generate a first control signal for the first transistor and a second control path configured to generate a second control signal for the second transistor. During an output signal transition the first control signal is configured to be driven to the second supply voltage during a rising output signal transition and the second control signal is configured to be driven to the first supply voltage during a falling output signal transition. After the output signal crosses a threshold voltage the first control signal is configured to be electrically connected to the output node and the second control signal is configured to be electrically connected to the output node. The feedback circuit includes an inverter configured to generate a feedback signal based on the output signal crossing a threshold voltage. The first and second transistors include low threshold voltage devices. The low threshold voltage devices are configured to limit output voltage swing to between a threshold voltage above the second supply voltage and the threshold voltage below the first supply voltage.

In an implementation, a method of operating a repeater circuit includes receiving an input signal, driving an output signal to an output node, operating in a first mode to provide a strong drive strength for the output signal, generating a feedback signal based on the output signal, and in response to the feedback signal, transitioning to a second mode to provide a reduced voltage swing for the output signal.

The described implementations may also include one or more of the following features. Driving the output signal includes operating a first transistor coupled between a first supply voltage and the output node and a second transistor coupled between the output node and a second supply voltage, wherein the first and second transistors are low threshold voltage devices configured to limit voltage swing at the output node. Operating in the first mode includes operating the first and second transistors as switches to provide the strong drive strength and operating in the second mode includes operating the first and second transistors as diode-connected devices to provide the reduced voltage swing. The method further includes generating a first control signal for the first transistor, generating a second control signal for the second transistor, driving the first control signal to the second supply voltage to enable the first transistor as a switch, the driving the first control signal initiating a rising transition of the output signal, driving the second control signal to the first supply voltage to enable the second transistor as a switch, the driving the second control signal initiating a falling transition of the output signal, and in response to the output signal crossing a predetermined threshold voltage electrically connecting the first control signal to the output node, and electrically connecting the second control signal to the output node. Generating the feedback signal includes detecting when the output signal crosses a predetermined threshold voltage and initiating the transitioning to the second mode responsive to the detecting.

In an implementation, a circuit may include an output circuit having a first transistor coupled between a first supply voltage and an output node and a second transistor coupled between the output node and a second supply voltage. The circuit may include a control circuit configured to operate the first and second transistors as switches during transitions of a signal at the output node, and operate the first and second transistors as diode-connected devices between the transitions of the signal at the output node. The control circuit may be configured to set an upper voltage of the output node to the first supply voltage minus a threshold voltage of the first transistor and a lower voltage of the output node to the second supply voltage plus a threshold voltage of the second transistor.

The described implementations may also include one or more of the following features. The circuit where the first and second transistors are low threshold voltage devices. The circuit may include: a feedback circuit configured to generate a feedback signal when the output node crosses a predetermined threshold voltage, where the control circuit is configured to transition between operating the first and second transistors as switches and operating the first and second transistors as diode-connected devices based on the feedback signal. The circuit where the control circuit may include a first control path configured to generate a first control signal for the first transistor, and a second control path configured to generate a second control signal for the second transistor, where the control circuit is further configured to connect the first and second control signals to the output node during operation of the first and second transistors as diode-connected devices. The circuit the control circuit includes a programmable bias circuit configured to adjust a voltage swing at the output node, and the first and second transistors are configured to operate with different threshold voltages selectable by the programmable bias circuit. The circuit where the control circuit may include a first connection path configured to connect a gate of the first transistor to the output node, and a second connection path configured to connect a gate of the second transistor to the output node.

Although the description has been described in detail, it should be understood that various changes, substitutions, and alterations may be made without departing from the spirit and scope of this disclosure as defined by the appended claims. The same elements are designated with the same reference numbers in the various figures. Moreover, the scope of the disclosure is not intended to be limited to the particular implementations described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding implementations described herein. Accordingly, the appended claims are intended to include within their scope such processes, machines, manufacture, compositions of matter, means, methods, or steps.

What is claimed is:

1. A repeater circuit, comprising:
an input circuit configured to receive an input signal;
a control circuit coupled to the input circuit;
an output circuit coupled to the control circuit and configured to drive an output signal; and
a feedback circuit coupled between the output circuit and the control circuit;
wherein the control circuit is configured to:
operate the output circuit in a switching mode; and
operate the output circuit in a diode-connected mode to provide a reduced voltage swing responsive to the feedback circuit.

2. The repeater circuit of claim 1, wherein the output circuit comprises:
a first transistor coupled between a first supply voltage and an output node; and
a second transistor coupled between the output node and a second supply voltage.

3. The repeater circuit of claim 2, wherein:
in the switching mode, the first and second transistors are configured to operate as switches; and
in the diode-connected mode, the first and second transistors are configured to operate as diode-connected devices.

4. The repeater circuit of claim 2, wherein the control circuit comprises:
a first control path configured to generate a first control signal for the first transistor; and
a second control path configured to generate a second control signal for the second transistor.

5. The repeater circuit of claim 4, wherein during an output signal transition:
the first control signal is configured to be driven to the second supply voltage during a rising output signal transition; and
the second control signal is configured to be driven to the first supply voltage during a falling output signal transition.

6. The repeater circuit of claim 4, wherein after the output signal crosses a threshold voltage:
the first control signal is configured to be electrically connected to the output node; and
the second control signal is configured to be electrically connected to the output node.

7. The repeater circuit of claim 1, wherein the feedback circuit comprises:
an inverter configured to generate a feedback signal based on the output signal crossing a threshold voltage.

8. The repeater circuit of claim 2, wherein the first and second transistors comprise low threshold voltage devices.

9. The repeater circuit of claim 8, wherein the low threshold voltage devices are configured to limit output voltage swing to between a threshold voltage above the second supply voltage and the threshold voltage below the first supply voltage.

10. A method of operating a repeater circuit, comprising:
receiving an input signal;
driving an output signal to an output node;
operating in a first mode to provide a strong drive strength for the output signal;
generating a feedback signal based on the output signal; and
in response to the feedback signal, transitioning to a second mode to provide a reduced voltage swing for the output signal.

11. The method of claim 10, wherein driving the output signal comprises:
operating a first transistor coupled between a first supply voltage and the output node and a second transistor coupled between the output node and a second supply voltage, wherein the first and second transistors are low threshold voltage devices configured to limit voltage swing at the output node.

12. The method of claim 11, wherein:
operating in the first mode comprises operating the first and second transistors as switches to provide the strong drive strength; and
operating in the second mode comprises operating the first and second transistors as diode-connected devices to provide the reduced voltage swing.

13. The method of claim 11, further comprising:
generating a first control signal for the first transistor;
generating a second control signal for the second transistor;
driving the first control signal to the second supply voltage to enable the first transistor as a switch, the driving the first control signal initiating a rising transition of the output signal; and
driving the second control signal to the first supply voltage to enable the second transistor as a switch, the driving the second control signal initiating a falling transition of the output signal; and
in response to the output signal crossing a predetermined threshold voltage:
electrically connecting the first control signal to the output node, and
electrically connecting the second control signal to the output node.

14. The method of claim 10, wherein generating the feedback signal comprises:
detecting when the output signal crosses a predetermined threshold voltage; and
initiating the transitioning to the second mode responsive to the detecting.

15. A circuit comprising:
an output circuit comprising:
a first transistor coupled between a first supply voltage and an output node;
a second transistor coupled between the output node and a second supply voltage;
a control circuit configured to:
operate the first and second transistors as switches during transitions of a signal at the output node; and
operate the first and second transistors as diode-connected devices between the transitions of the signal at the output node; and
set an upper voltage of the output node to the first supply voltage minus a threshold voltage of the first transistor and a lower voltage of the output node to the second supply voltage plus a threshold voltage of the second transistor.

16. The circuit of claim 15, wherein the first and second transistors are low threshold voltage devices.

17. The circuit of claim 15, further comprising:
a feedback circuit configured to generate a feedback signal when the signal at the output node crosses a predetermined threshold voltage; and
wherein the control circuit is configured to transition between operating the first and second transistors as switches and operating the first and second transistors as diode-connected devices based on the feedback signal.

18. The circuit of claim 15, wherein the control circuit comprises:
a first control path configured to generate a first control signal for the first transistor;
a second control path configured to generate a second control signal for the second transistor; and
wherein the control circuit is further configured to connect the first and second control signals to the output node during operation of the first and second transistors as diode-connected devices.

19. The circuit of claim 15, wherein:
the control circuit comprises a programmable bias circuit configured to adjust a voltage swing at the output node; and
the first and second transistors are configured to operate with different threshold voltages selectable by the programmable bias circuit.

20. The circuit of claim 15, wherein the control circuit comprises:
a first connection path configured to connect a gate of the first transistor to the output node; and
a second connection path configured to connect a gate of the second transistor to the output node.
